(19) United States
(12) Patent Application Publication
(10) Pub. No.: US 2024/0124751 A1
(43) Pub. Date: Apr. 18, 2024

(54) Pressure-sensitive adhesive based on hydrogenated polyvinylaromatic-polydiene block copolymers

(71) Applicant: TESA SE, Norderstedt (DE)

(72) Inventors: Thilo DOLLASE, Hamburg (DE); Jos TASCHE, Ahrensburg (DE); Jan Ole PÖHLS, Hamburg (DE)

(21) Appl. No.: 18/187,350

(22) Filed: Mar. 21, 2023

(30) Foreign Application Priority Data
Mar. 31, 2022 (DE) 102022107747.0

(51) Int. Cl. C09J 7/38; C09J 7/26; C09J 11/08; C09J 153/02

(52) U.S. Cl. CPC C09J 7/387; C09J 7/26; C09J 11/08; C09J 153/025; C09J 2301/302; C09J 2301/408

(57) ABSTRACT

The invention relates to a pressure-sensitive adhesive comprising a) at least 38 wt % and at most 58 wt % of an elastomer component, where i) the elastomer component comprises at least 60 wt %, based on the elastomer component, of hydrogenated polyvinylaromatic-polydiene block copolymer having a polyvinylaromatic fraction of at least 18 wt % and a peak molecular weight of 80 000 to 500 000 g/mol, determined by GPC (Test I); ii) the polydiene blocks are substantially fully hydrogenated; and iii) the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic and B=ethylene and butylene or ethylene and propylene, and Z=derivative of a coupling substance, and where the ethylene fraction in the B blocks is at least 50 wt %; b) a tackifier resin component, c) a plasticizer component, and d) optionally further adjuvants, where the fraction of the elastomer component is based on the total weight of the pressure-sensitive adhesive.

The present invention relates to a pressure-sensitive adhesive based on hydrogenated polyvinylaromatic-polydiene block copolymers and to an adhesive tape with at least one layer of the pressure-sensitive adhesive, and also to the use thereof.

Adhesive and adhesive tapes are used in general to assemble two substrates so as to form a durable or permanent bond. Specific adhesive tape products have a foam layer and are used for example in the automotive industry for the permanent bonding of components on the bodywork or in the engine area. Typical examples of this are the bonding of insignia and also the securement of plastic parts and rubber door seals. A common material for plastic ancillary parts is PP/EPDM, PP/EPM or PP/EPR.

Examples of self-adhesive tapes for the bonding of parts to automotive finishes are disclosed for example in WO 2008/070386 A1 and in U.S. Pat. No. 4,415,615 A.

In spite of a multiplicity of adhesives and adhesive tapes, innovative substrates and also increasing requirements in the end-use application make it necessary to develop new pressure-sensitive adhesives (PSAs), formulations and adhesive tape designs. Even known component materials such as PP/EPDM, PP/EPM or PP/EPR still pose challenges for high-performance PSAs, because of, for instance, the continually rising requirements, such as the shear strength of a bonded assembly at elevated temperatures, for example.

Furthermore, in view of the ongoing trend in the transport sector and particularly in the automotive industry to further reduce the weight of, for instance, a car and hence to reduce the fuel consumption, the use of adhesive tapes is on the rise. As a result of this, adhesive tapes are being used for applications for which previous adhesive tape products were neither envisaged nor developed, and consequently, in addition to the mechanical load and the critical substrates for bonding applications, there are also continually rising requirements particularly for permanent bonds in respect of UV stability and weathering stability.

There exists, therefore, the requirement for a self-adhesive tape product on the one hand to have enhanced adhesion to low-energy surfaces such as PP/EPDM, PP/EPM or PP/EPR and on the other hand to preserve an outstanding performance profile even under extreme climatic conditions.

The adhesive tape must, additionally, suit the production processes as well. In view of ongoing automation of production processes, and of the desire for economical ways of manufacture, the adhesive tape, as soon as it has been positioned at the correct point, must exhibit sufficient adhesion and in some cases withstand high shearing forces as well. For these purposes it is advantageous if the adhesive tapes exhibit high tack and the adhesives adapt rapidly to a variety of substrates, so that effective wetting and hence high levels of peel adhesion are attained within a very short time.

Since the last aspect particularly, namely the rapid attainment of constant levels of peel adhesion, and hence a low tendency to adapt to a variety of surfaces, is difficult to achieve with resin-modified acrylate PSAs or straight acrylate PSAs, there are frequent descriptions instead of synthetic rubbers or blends with synthetic rubbers as suitable materials for bonding to non-polar surfaces. EP 0 349 216 A1 and EP 0 352 901 A1 describe two-phase blends consisting of a polyacrylate and a synthetic rubber, preferably a styrene block copolymer, which are praised particularly for bonding to paints and varnishes. Blend systems, however, may have the disadvantage that the morphology of the blend can change over time and/or with increasing temperature, and this may be manifested in a macroscopic change in the polymer quantity and/or product quality. In extreme cases, moreover, there may be complete separation of the polymer components and certain blend components may accumulate on surfaces over time, with a possible consequent change in the adhesion. Since generally there is great cost and complexity involved—for example, through the use of compatibilizers as disclosed in U.S. Pat. No. 6,379,791 A—in producing blends for bonding applications that exhibit long-term and thermal stability, these blend systems are not always advantageous.

EP 2 226 369 A1 describes an adhesive tape which has a viscoelastic acrylate foam carrier clad with at least one layer of PSA. The PSA is based on a chemically crosslinked rubber, preferably a synthetic rubber crosslinked by means of electron beam curing. The adhesive tapes described there exhibit not only good levels of peel adhesion on various paint and varnish coats but also sufficient cohesion at high temperatures. As rubbers which can be used, there is a general statement of polyvinylaromatic-polydiene block copolymers and hydrogenated derivatives. The only formulations explicitly described are based on polystyrene-polyisoprene block copolymers (so-called SIS). Particular suitability on PP/EPDM, PP/EPM or PP/EPR is not described.

DE 10 2012 212 883 A1 discloses adhesive tapes having a viscoelastic acrylate foam carrier bearing at least one applied bonding layer based on a mixture of synthetic rubbers. Emphasis is given to polyvinylaromatic-polydiene block copolymers and hydrogenated derivatives. Explicitly described, as well as formulations with polystyrene-polyisoprene block copolymers, are those based on polystyrene-polybutadiene block copolymers (so-called SBS), which already exhibit advantages over those containing polyisoprene in relation to long-term stability.

Further examples of self-adhesive tapes having a foam carrier located on which is a synthetic rubber-based PSA are described in EP 1 417 255 B1, in WO 2008/073669 A1 and in EP 3 243 886 A1 and also EP 3 336 153 A1. A common feature of the disclosures in these publications is that, despite a general statement of polyvinylaromatic-polydiene block copolymers and hydrogenated derivatives, the explicit disclosure is nevertheless confined to formulations based on polystyrene-polyisoprene block copolymers.

PSAs based on hydrogenated polyvinylaromatic-polydiene block copolymers are known.

DE 10 2006 037 627 A1 describes PSAs which comprise hydrogenated block copolymers, and also tackifier resin and polyisobutylene. In terms of the hydrogenated block copolymers, the description makes no specific selection, while the examples mention those with a polyvinylaromatic fraction of 13 wt %. The PSA may be applied on a carrier material, but this material, given that the target application is that of surface protection sheets, is a not a foamed material but one in the form of a film.

The disclosure in DE 10 2007 021 504 A1 embraces formulations which comprise polystyrene-poly(ethylene/butylene) block copolymers (so-called SEBS) and a high fraction of liquid resin. Although the description gives no specific details concerning the polyvinylaromatic fraction, the examples in DE 10 2007 021 504 nevertheless indicate that, based on hydrogenated polystyrene-polydiene block copolymers, advantageous PSAs are typically generated through selection of block copolymers of low polyvinylaromatic fraction.

EP 0 885 942 A1 proposes PSAs based on hydrogenated polystyrene-polydiene block copolymers. Target applications lie in the field of bonding to skin. Example compositions utilize primarily hydrogenated polystyrene-polydiene block copolymers of relatively low molar mass within the elastomer component. Hydrogenated polystyrene-polydiene block copolymers of higher molar mass, which are needed for thermal shear strength, are employed at most in a minor amount (for Example 10: 5.5% of Kraton G1650; Example 12: 15.0% of Kraton G1650). EP 991 730 B1 teaches similar formulations.

EP 0 758 009 A2 describes PSAs based on hydrogenated polystyrene-polydiene block copolymers. The fraction of hydrogenated polystyrene-polydiene block copolymers in the overall formulation is not more than 20%. At such low fractions of hydrogenated polystyrene-polydiene block copolymers, it can be assumed that the thermal shear strength is low. Moreover, a very high plasticizer content, of 60% to 95%, is proposed.

WO 2016/130627 A1 claims formulations with hydrogenated polystyrene-polydiene block copolymers which have a high vinyl fraction in the hydrogenated polydiene block. The example formulations always contain a very high fraction of plasticizer.

Although, therefore, the utilization of hydrogenated block copolymers for formulating PSAs is known per se to the skilled person, there are, remarkably, no specific examples that have been described of PSAs of this kind for self-adhesive tapes having a foam carrier, more particularly a viscoelastic, acrylate-based foam carrier, and this suggests particular difficulty in the realization of such systems. The fundamental difficulty of tackifying hydrogenated polyvinylaromatic-polydiene block copolymers such as SEBS has also already been reported by Jagisch and Tancrede in D. Satas, Handbook of Pressure Sensitive Adhesive Technology, 3^{rd} edn., 1999, D. Satas & Associates, Warwick, p. 367, table 16-5.

It is an object of the invention, therefore, to portray a pressure-sensitive adhesive which affords good bonding performance on PP/EPDM, PP/EPM or PP/EPR, and also to provide an adhesive tape having at least one layer of said adhesive. Additionally sought is a self-adhesive product which consists of a foam carrier and of a PSA of this kind applied on at least one side of the foam carrier, the product exhibiting an outstanding shear strength even at high temperatures and affording in particular improved longevity of elastomers saturated in the main polymer chain by comparison with elastomers with unsaturated main chain.

This object is achieved, unexpectedly, by a pressure-sensitive adhesive as set down in the main claim. The dependent claims provide advantageous refinements of the subject matter of the invention.

A first subject of the present invention, therefore, is a pressure-sensitive adhesive comprising:
a) at least 38 wt % and at most 58 wt % of an elastomer component, where
   i) the elastomer component comprises at least 60 wt %, based on the elastomer component, of hydrogenated polyvinylaromatic-polydiene block copolymer having a polyvinylaromatic fraction of at least 18 wt % and a peak molecular weight of 80 000 to 500 000 g/mol, determined by GPC (Test 1);
   ii) the polydiene blocks are substantially fully hydrogenated; and
   iii) the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic and B=ethylene and butylene or ethylene and propylene, and Z=derivative of a coupling substance, and where the ethylene fraction in the B blocks is at least 50 wt %;
b) a tackifier resin component,
c) a plasticizer component, and
d) optionally further adjuvants,
   where the fraction of the elastomer component is based on the total weight of the pressure-sensitive adhesive.

By substantially fully hydrogenated in the context of the present invention is meant a degree of hydrogenation of at least 90%, preferably at least 95% and more preferably of at least 99%. Hydrogenated block copolymers in the context of the present invention are those in which the polydiene blocks are in substantially fully hydrogenated form.

Examples of coupling substances can be found in references including Holden (G. Holden, D. R. Hansen in Thermoplastic Elastomers, G. Holden, H. R. Kricheldorf, R. P. Quirk (Eds.), 3^{rd} edn. 2004, C. Hanser, Munich, p. 49f), without wishing to impose any restriction.

A pressure-sensitive adhesive (PSA) is an adhesive which even under relatively weak applied pressure allows a durable bond to virtually any substrates and which where appropriate after use may be redetached from the substrate substantially without residue. At room temperature, a PSA has permanent pressure-sensitive adhesion, thus having a sufficiently low viscosity and a high touch-tackiness, and so it wets the surface of the respective bonding substrate even at low contact pressure. The bondability of the adhesive derives from its adhesive properties, and the redetachability from its cohesive properties.

### Elastomer Component

In the context of the present invention it has emerged in particular that the advantageous combination of properties, particularly the high shear strength at high temperatures, is achievable by a balanced harmonization of the individual components of the PSA, but not by those which have been widely disclosed in the prior art.

A consequence of too low a fraction of vinylaromatic block copolymers is that the thermal shear strength of the PSA layer is relatively low. Too high a fraction of vinylaromatic block copolymers, in turn, has the consequence that the PSA layer is barely still pressure-sensitively adhesive.

Preference is therefore given to an embodiment in which the hydrogenated polyvinylaromatic-polydiene block copolymers contained in the elastomer component have a polyvinylaromatic fraction of 20 to 36 wt %, preferably 25 to 33 wt %, based on the overall hydrogenated polyvinylaromatic-polydiene block copolymers. The fraction of polyvinylaromatics in the polyvinylaromatic-polydiene block copolymers may be determined, for example, via ¹H or ¹³C NMR (nuclear-spin resonance spectroscopy, Test IX). For commercially available hydrogenated polyvinylaromatic-polydiene block copolymers, the fraction of polyvinylaromatics can also be taken from the manufacturer information.

It has surprisingly emerged that the amount of elastomer component present in the adhesive of the invention affects how suitable the PSA is for the bonding of non-polar substrates such as PP and EPR. Accordingly, in the context of the present invention, a decrease in the holding power has been observed if the fraction of elastomer component in the PSA was outside the claimed range of 38 to 58 wt %, based on the total weight of the PSA. Particularly good results have been achievable if the fraction was adapted still further. An embodiment is therefore preferred in which the fraction of elastomer component in the PSA, based on the total weight of the PSA, is 40 to 55 wt %.

The hydrogenated polyvinylaromatic-polydiene block copolymers used in the invention are notable for their linear ABA construction and also linear (AB)ₙZ construction with n=2 or radial (AB)ₙ construction and also radial (AB)ₙZ construction with n≥3 and for their ethylene fraction. Vinylaromatics for constructing the block A comprise preferably styrene, α-methylstyrene and/or other styrene derivatives. The block A may therefore take the form of a homopolymer or a copolymer. More preferably the block A is a polystyrene.

The hydrogenated polyvinylaromatic-polydiene block copolymers used in the PSA of the invention are preferably polymers whose vinylaromatic blocks (A blocks) contain styrene and which are formed by polymerization of dienes (B blocks) and subsequent hydrogenation, meaning that the B blocks are constructed preferably of ethylene and butylene or of ethylene and propylene. Preferred block copolymers used are those which in respect of the polydiene blocks (B blocks) are substantially completed hydrogenated.

To improve further the profile of properties of the PSA of the invention, it has proven to be advantageous if the elastomer component, in addition to a hydrogenated polyvinylaromatic-polydiene block copolymer having a linear or radial construction, comprises a hydrogenated polyvinylaromatic-polydiene block copolymer A′B′, where A′ and B′ correspond preferably to A and B as defined above and the polydiene blocks are substantially fully hydrogenated.

In one preferred embodiment the hydrogenated diblock copolymer is one having a peak molecular weight, determined via GPC (Test I), of less than 100 000 g/mol. The fraction of the hydrogenated diblock copolymer in the elastomer component is preferably not more than 25 wt %, more preferably 15 to 20 wt %, based in each case on the total weight of the elastomer component.

In an additionally preferred embodiment, the elastomer component additionally has at least one hydrogenated diblock copolymer having a peak molecular weight, determined by GPC, of greater than 100 000 g/mol, with the fraction of these hydrogenated diblock copolymers being limited preferably to 40 wt %, more preferably 15 to 35 wt %, based in each case on the total weight of the elastomer component.

### Tackifier Resin Component

The PSA of the invention additionally comprises a tackifier resin component. The fraction of the tackifier resin component, based on the total weight of the PSA, is preferably 35 to 60 wt %. The tackifier resin component comprises one or more tackifier resins. The tackifier resins are selected such that they are primarily miscible (compatible) with the regions of the PSA that are dominated by the B blocks. At least one tackifier resin is notable, furthermore, for having a softening temperature by the ring-and-ball method of greater than 95° C., but preferably not more than 135° C. The softening temperature here may be determined by Test II as described below. Preferably all of the tackifier resins in the tackifier resin component have a softening temperature within this range.

Tackifier resin components used are preferably those selected from the group consisting of partially or completely hydrogenated resin based on dicyclopentadiene, partially or completely hydrogenated hydrocarbon resins based on C₅, C₅/C₉ or C₉ monomer streams, polyterpene resins based on α-pinene and/or β-pinene and δ-limonene, and a hydrogenated polymer of pure C₈ or C₉ aromatics, the resin being partially or completely hydrogenated.

“Partially hydrogenated” in the context of the present invention refers to a degree of hydrogenation of at least 80%, preferably at least 85%.

The adhesive of the invention preferably has at least one tackifier resin component that has a DACP (diacetone alcohol cloud point) of at least 35° C., preferably of at least 55° C. The DACP may be determined here according to Test III as described below.

In an additionally preferred embodiment, the PSA of the invention comprises at least one tackifier resin component which has an MMAP (mixed methylcyclohexane aniline point) of greater than 45° C., preferably greater than 75° C. The MMAP may be determined according to Test IV as described below.

### Plasticizer Component

As well as the elastomer component and the tackifier resin component, the PSA of the invention additionally comprises a plasticizer component. The fraction of plasticizer component, based on the total weight of the PSA, is preferably not more than 20 wt %, preferably 2 to 15 wt %, more preferably 4 to 12 wt %. It has surprisingly emerged that a plasticizer component fraction in the stated amounts is sufficient to give a PSA having sufficiently high bond strength, this contrasting with the teaching of the prior art where the starting point is a plasticizer content of 60 to 95 wt %. The plasticizer component may comprise one or more plasticizers.

The plasticizer is preferably selected from the group consisting of ethylene/propylene copolymer, ethylene/butylene copolymer, butylene/iso-butylene (co)polymer, butylene homopolymer, iso-butylene homopolymer and mineral oil.

In a first preferred embodiment, the plasticizer (“Type 1”) has a weight-average molecular mass, determined by GPC (Test I), of at least 10 000 g/mol, preferably of at least 100 000 g/mol, and at most 1 000 000 g/mol. In these cases the plasticizer is preferably an ethylene/propylene copolymer or ethylene/butylene copolymer with linear or radial structure.

In a further preferred embodiment, the plasticizer (“Type 2”) has a weight-average molar mass, determined via GPC (Test I), of at least 3000 g/mol and at most 50 000 g/mol, preferably at most 20 000 g/mol. In this case the plasticizer is preferably a butylene/isobutylene (co)polymer.

In a third embodiment, the plasticizer (“Type 3”) is selected from mineral oils.

### Further Adjuvants

In order further to adapt the profile of properties of the PSA of the invention, it may be admixed with further adjuvants. These are preferably adjuvants selected from the group consisting of primary antioxidants such as sterically hindered phenols, secondary antioxidants such as phosphites or thioethers, process stabilizers such as C-radical scavengers, light stabilizers such as UV absorbers or sterically hindered amines, processing assistants, and further elastomers such as those based on pure hydrocarbons such as unsaturated polydienes, naturally or synthetically generated polyisoprene or polybutadiene, elastomers with substantial chemical saturation such as saturated ethylene-propylene copolymers, α-olefin copolymers, polyisobutylene, butyl rubber, ethylene-propylene rubber and functionalized hydrocarbons such as halogen-containing, acrylate-containing or vinyl ether-containing polyurethanes.

### Pressure-Sensitive Adhesive (PSA)

The PSA of the invention is notable for a range of physical properties which make it especially suitable for use in the bonding of low-energy surfaces such as PP/EPDM, PP/EPM and PP/EPR but also other surfaces such as steel. Here it has been found, surprisingly, that these advantageous properties could be obtained even at high temperatures.

The PSA of the invention is notable in particular for a profile of requirements as summarized in the table below. Particularly noteworthy here is the good bonding performance on PP/EPDM, PP/EPM and PP/EPR.

TABLE 1
Profile of PSA requirements

| Requirement | Property | Performance | | Preferable | | Very preferable | |
|---|---|---|---|---|---|---|---|
| Bond | Peel adhesion | >3 | N/cm | >5 | N/cm | >7 | N/cm |
| strength | (steel) | | | | | | |
| (Test Va) | | | | | | | |
| (Test Vb) | Peel adhesion | >3 | N/cm | >5 | N/cm | — | |
| | (PE) | | | | | | |
| Thermal | SAFT (200 g) | >120° | C. | >160° | C. | >200° | C. |
| shear | | | | | | | |
| strength | | | | | | | |
| (SAFT) (Test | | | | | | | |
| VI) | | | | | | | |
| Holding | HP 80° C. | >800 | min | >1500 | min | >10 000 | min |
| power (HP) | PP/EPR | | | | | | |
| (Test VIIa) | (0.5 kg) | | | | | | |
| (Test VIIb) | HP 80° C. steel | >5000 | min | >8000 | min | >10 000 | min |
| | (0.5 kg) | | | | | | |

In one preferred embodiment, therefore, the PSA has a peel adhesion on steel of more than 3 N/cm, preferably more than 5 N/cm and more particularly more than 7 N/cm, determined in each case by the described Test method Va.

Additionally preferred is an embodiment in which the PSA has a peel adhesion on PE of more than 3 N/cm, preferably more than 5 N/cm, determined in each case by the described Test method Vb.

In an additionally preferred embodiment, the PSA has a thermal shear strength (shear adhesive failure temperature: SAFT) at 200 g of more than 120° C., preferably more than 160° C. and more preferably more than 200° C., in each case determined by Test method VI.

Additionally preferred is an embodiment in which the PSA has a holding power (HP) at 80° C. and 0.5 g on PP and/or EPR of more than 800 min, preferably more than 1500 min and more preferably more than 10 000 min, determined in each case by Test VIIa.

The PSA preferably has a holding power (HP) at 80° C. and 0.5 g on steel of more than 5000 min, preferably more than 8000 min and more preferably more than 10 000 min, in each case determined by Test VIIb.

### Adhesive Tape

A further subject of the present invention is an adhesive tape having a carrier which bears at least one layer of the PSA of the invention. Likewise a subject of the invention is an adhesive tape having a carrier which bears on both sides a layer of PSA of the invention, with the two layers consisting of the same or different PSAs. A subject of the invention, furthermore, is an adhesive tape having a carrier which bears on one side an applied layer of a PSA of the invention and on the other side a further applied adhesive not of the invention (such as, for example, a polystyrene-polybutadiene block copolymer (SBS)-based PSA or a polystyrene-polyisoprene block copolymer (SIS)-based PSA or a PSA based on a blend of poly(meth)acrylate and polystyrene-polydiene). The latter may be pressure-sensitively adhesive or non-pressure-sensitively adhesive and/or heat-sealable.

The general expression “adhesive tape” encompasses, for the purposes of this invention, all sheetlike structures such as two-dimensionally extended films or film portions, tapes with extended length and limited width, tape portions and the like, and lastly also diecuts or labels.

The adhesive tape therefore has a longitudinal extent and a lateral extent. The adhesive tape also has a thickness which extends perpendicularly to the two extents, and the lateral extent and longitudinal extent may be several times greater than the thickness. The thickness is as far as possible the same, preferably substantially the same, over the entire surface extent of the adhesive tape as defined by length and width.

The adhesive tape is present more particularly in web form. A web is understood to mean an article whose length is several times greater than its width and the width is configured to be approximately, preferably exactly, consistent along the entire length. The adhesive tape may be produced in the form of a roll, in other words wound up onto itself in the form of an Archimedean spiral.

The carrier material preferably comprises a film. Appropriate films include, in particular, polyester films, and more preferably here films based on polyethylene terephthalate (PET). Polyester films are preferably biaxially oriented. Additionally conceivable are films of monoaxially oriented polypropylene, biaxially oriented polypropylene or biaxially oriented polyethylene. This listing is intended to demonstrate examples: the skilled person is aware of further systems which conform to the concept of the present invention.

The carrier material may also comprise an elastically or plastically deformable film such as one composed of polyurethane or polyolefin (maximum elongation to ISO 527 of greater than 100% or even greater than 300%). Among the polyurethanes, polyester polyurethanes and polyether polyurethanes are particularly preferred.

With further preference the carrier is a foam carrier, more preferably a foam carrier composed of a PE or PU foam, and more particularly a poly(meth)acrylate foam. The foam here may have any known form of foam cells—that is, may be open-celled or closed-celled. The foaming may have been brought about by chemical or physical foaming means, by forceful introduction of gas, or, in particular, air (“frothing”) or by introduction of hollow beads, without this listing being conclusive—instead it should be understood merely as an example. Specific examples are hollow glass beads, hollow ceramic beads, hollow metal beads, and expanded, expandable and pre-expanded microballoons. Combinations of different stated and further foaming methods are likewise possible.

The carrier used is preferably a foam carrier with a poly(meth)acrylate as framework structure. The glass transition temperature of the poly(meth)acrylate is advantageously below usage temperature, more particularly below 0° C., very preferably below −20° C., and so it has a viscoelastic character. The glass transition temperature here should be understood as the quasi-static glass transition temperature ascertained by DSC according to Test VIII. The poly(meth)acrylate is preferably obtainable by a free or controlled radical polymerization of one or more (meth)acrylic acids or (meth)acrylic esters and with particular preference is crosslinked thermally. In one particularly preferred embodiment, therefore, the framework structure forming the foam carrier is a thermally crosslinked poly(meth)acrylate.

One preferred variant uses thermally crosslinkable poly(meth)acrylate-based polymers for the foam carrier layer. The composition advantageously comprises a polymer consisting of (a1) 70 to 100 wt % of acrylic esters and/or methacrylic esters and/or the corresponding free acids of the following structural formula:

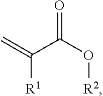

where R¹ is H or CH₃ and R² is H or alkyl chains having 1 to 14 C atoms;
(a2) 0 to 30 wt % of olefinically unsaturated monomers having functional groups; and
(a3) optionally further acrylates and/or methacrylates and/or olefinically unsaturated monomers, preferably with a fraction between 0 to 5 wt %, which are copolymerizable with component (a1) and have a functional group which via the crosslinking reagent leads to covalent linking, with the weight figures being based on the polymer.

Employed with preference for the monomers (a1) are acrylic monomers, comprising acrylic and methacrylic esters with alkyl groups consisting of 1 to 14 C atoms. Specific examples, with wishing to impose any restriction by this listing, are methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate and branched isomers thereof such as 2-ethylhexyl acrylate, for example. Other classes of compound for use that may likewise be added in small amounts under (a1) are cyclohexyl methacrylates, isobornyl acrylate and isobornyl methacrylates. The fraction thereof is preferably not more than up to 20 wt %, more preferably not more than up to 15 wt %, based in each case on the total amount of monomers (a1).

Preference is given to using, for (a2), monomers such as, for example, maleic anhydride, itaconic anhydride, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate, this listing not being conclusive.

Likewise preferred for use for component (a2) are aromatic vinyl compounds where the aromatic nuclei consist preferably of C₄ to C₁₈ building blocks and may also include heteroatoms. Particularly preferred examples are styrene, 4-vinylpyridine, N-vinylphthalimide, methylstyrene and 3,4-dimethoxystyrene, this listing not being conclusive.

Particularly preferred examples for component (a3) are hydroxyethyl acrylate, 3-hydroxypropyl acrylate, hydroxyethyl methacrylate, 3-hydroxypropyl methacrylate, 4-hydroxybutyl acrylate, 4-hydroxybutyl methacrylate, allyl alcohol, itaconic acid, acrylamide and cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, β-acryloyloxypropionic acid, trichloroacrylic acid, fumaric acid, crotonic acid, aconitic acid, dimethylacrylic acid and 4-vinylbenzoic acid, this listing not being conclusive. Monomers of component (a3) may advantageously also be selected such that they contain functional groups which support subsequent radiation crosslinking, through electron beams or UV, for example. Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate, with this listing not being conclusive.

The comonomers are preferably selected such that the glass transition temperature (determined by Test VIII) of the polymers is below the usage temperature.

Suitable processes for producing such carriers are described for example in DE 10 2012 212883.

In a further preferred variant, radiation-curable, poly(meth)acrylate-based polymers are used for the foam carrier layer, with the curing taking place utilizing, in particular, UV radiation and/or electron beams. Implementation possibilities for such foam carrier layers and production processes can be found for example in EP 2 403 916 A1 in paragraphs [0019] to [0033], in EP 2 848 665 A1 in paragraphs [0098] to [0154], in EP 2 226 369 A1 in paragraphs [0020] to [0034] and in EP 2 403 916 A1 in paragraphs [0014] to [0022].

The PSA is applied at least to one side of the carrier, with preference being given likewise to embodiments in which the carrier is coated on both sides with the PSA. The PSA may be applied to the carrier by processes known to the skilled person, as for example by means of knife processes, nozzled knife processes, rolling-rod nozzle processes, extrusion die processes, casting die processes and casting processes. Likewise in accordance with the invention are application processes such as roll application processes, printing processes, screen-printing processes, halftone roll processes, inkjet processes and spraying processes. Hotmelt processes where the PSA is applied via extrusion and/or nozzle are preferred. The application process involved, however, need not entail direct coating. The PSA may also first be coated in some other way and then laminated onto the carrier in a second step. Where appropriate, further layers or plies of material may be subsequently used for coating or laminated in-line or off-line, and so multi-layer/multi-ply product constructions may also be produced. Such further layers may introduce specific additional properties into the adhesive tape, such as mechanical properties, for example. They may also promote the anchorage between adhesive and carrier or suppress the migration of individual constituents from one another into the other.

The layer thickness of the PSA on the carrier is preferably between 15 μm and 500 μm, more preferably between 25 μm and 250 μm; more particularly it is at most 150 μm or even at most 100 μm. Example layer thicknesses lie at 30 μm, 50 μm, 75 μm, 100 μm, 125 μm, 150 μm, 200 μm and 250 μm. Not excluded, however, are also significantly higher layer thicknesses of 500 to 2000 μm, such as more particularly 1000 to 1500 μm. For example the thickness may be 750 or 1000 μm.

The total thickness of an adhesive tape may be in the range of 25 μm and 5 mm, preferably between 50 μm and 2 mm, more preferably between 100 μm and 1500 μm. Example adhesive tape thicknesses lie at 200 μm, 250 μm, 300 μm, 500 μm, 800 μm, 1000 μm and 1200 μm.

The PSA of the invention has proven to be advantageous in particular in connection with low-energy surfaces such as PP/EPDM, PP/EPM and PP/EPR. A further subject of the present invention, therefore, is the use of the PSA of the invention or of the adhesive tape of the invention for bonding a substrate comprising ethylene (co)polymer, propylene (co)polymer, EPR, EPM and/or EPDM. More particularly the PSA of the invention or the adhesive tape of the invention is used for bonding an ancillary component comprising ethylene (co)polymer, propylene (co)polymer, EPR, EPM and/or EPDM in or on a car/vehicle.

A further subject of the present invention is the use of the PSA of the invention or of the adhesive tape of the invention for bonding other substrates such as, in particular, other plastics and metals.

Claimed lastly is a substrate (more particularly component) comprising ethylene (co)polymer, propylene (co)polymer, EPR, EPM and/or EPDM or another kind of plastic, this substrate bearing an adhesive tape applied by means of a PSA layer of the invention. Very preferably the adhesive tape comprises a foam carrier, and here more particularly poly(meth)acrylate as framework structure.

The present invention is elucidated in more detail by the following examples, which should in no way be understood as limiting the concept of the invention.

### EXAMPLES

### I. Chemicals Used

TABLE 2
Chemicals used

| Component | Chemical | Description | Manufacturer |
|---|---|---|---|
| Elastomer | Septon 2005 | SEPS; | Kuraray |
| | | PS fraction 20 wt %; | |
| | | Diblock fraction: 0 wt % | |
| | | Peak MW*: 265 000 g/mol | |
| | Septon 2004 | SEPS; | Kuraray |
| | | PS fraction 18 wt %; | |
| | | Diblock fraction: 0 wt % | |
| | | Peak MW*: 100 000 g/mol | |
| | Septon 2002 | SEPS; | Kuraray |
| | | PS fraction 30 wt %; | |
| | | Diblock fraction: 0 wt % | |
| | | Peak MW*: 56 000 g/mol | |
| | Septon 1020 | SEP Diblock; | Kuraray |
| | | PS fraction 36 wt %; | |
| | | Diblock fraction: 100 wt % | |
| | Kraton G1650 | SEBS; | Kraton Corp. |
| | | PS fraction 30 wt %; | |
| | | Diblock fraction: 0 wt % | |
| | | Peak MW*: 89 000 g/mol | |
| | Kraton G1654 | SEBS; | Kraton Corp. |
| | | PS fraction 31 wt %; | |
| | | Diblock fraction: 0 wt % | |
| | | Peak MW*: 160 000 g/mol | |
| | Kraton G1651 | SEBS; | Kraton Corp. |
| | | PS fraction 33 wt %; | |
| | | Diblock fraction: 0 wt % | |
| | | Peak MW*: 210 000 g/mol | |
| | Kraton G1633 | SEBS; | Kraton Corp. |
| | | PS fraction 30 wt %; | |
| | | Diblock fraction: 0 wt % | |
| | | Peak MW*: 365 000 g/mol | |
| | Kraton G1657 | SEBS; | Kraton Corp. |
| | | PS fraction 13 wt %; | |
| | | Diblock fraction: 29 wt % | |
| | | Peak MW*: 120 000 g/mol | |
| | Kraton G1642 | SEBS; | Kraton Corp. |
| | | PS fraction 21 wt %; | |
| | | Diblock fraction: 0 wt % | |
| | | Peak MW*: 112 000 g/mol | |
| | | Ethylene content: <50 wt % | |
| | Kraton G1726 | SEBS; | Kraton Corp. |
| | | PS fraction 30 wt %; | |
| | | Diblock fraction: 70 wt % | |
| | | Peak MW*: 65 000 g/mol | |
| | Kraton G1702 | SEP Diblock; | Kraton Corp. |
| | | PS fraction 28 wt %; | |
| | | Diblock fraction: 100 wt % | |
| | Hybrar 7125 | SEPS; | Kuraray |
| | | PS fraction 20 wt %; | |
| | | Diblock fraction: 0 wt % | |
| | | Peak MW*: 110 000 g/mol | |
| | | Ethylene content: <50 wt % | |
| | YH-602 | SEBS (radial); | Sinopec |
| | | PS fraction 35 wt %; | |
| | | Diblock fraction: 15 wt % | |
| | | Peak MW**: 230 000 g/mol | |
| Harz | Eastotac H100W | C₅ HC resin; | Eastman |
| | | Soft. point: 100° C. | Chemical |
| | | MMAP: 82° C. | |
| | | DACP: 82° C. | |
| | | Fully hydrogenated | |
| | Regalite R1125 | C₉ HC resin, | Eastman |
| | | Soft. point: 125° C. | Chemical |
| | | MMAP: 88° C. | |
| | | DACP: 56° C. | |
| | | Fully hydrogenated | |
| | Sukorez SU120 | DCPD- HC resin; | Kolon |
| | | Soft. point: 120° C. | |
| | | MMAP: 58° C. | |
| | | DACP: 76° C. | |
| | | Fully hydrogenated | |
| | Eastotac H115W | C₅ HC resin; | Eastman |
| | | Soft. point: 115° C. | Chemical |
| | | MMAP: 82° C. | |
| | | DACP: 82° C. | |
| | | Fully hydrogenated | |
| | Regalite R7100 | C₉ HC resin; | Eastman |
| | | Soft. point: 100° C. | Chemical |
| | | MMAP: 66° C. | |
| | | DACP: 14° C. | |
| | | 70 wt % hydrogenated | |
| | Sukorez SU90 | DCPD HC resin; | Kolon |
| | | Soft. point: 90° C. | |
| | | MMAP: not determined | |
| | | DACP: not determined | |
| | | Fully hydrogenated | |
| | Regalite R1090 | C₉ HC resin; | Eastman |
| | | Soft. point: 90° C. | Chemical |
| | | MMAP: 77° C. | |
| | | DACP: 39° C. | |
| | | Fully hydrogenated | |
| Plasticizer | Kraton G1750 | “Type 1” | Kraton Corp. |
| | | Ethylene-propylene copolymer | |
| | | Peak MW: 390 000 g/mol | |
| | | MW: 365 000 g/mol | |
| | Keltan 500R | “Type 1” | Arlanxeo |
| | | Ethylene-propylene copolymer | |
| | | Peak MW: 110 000 g/mol | |
| | | MW: 114 000 g/mol | |
| | Indopol H100 | “Type 2” | Ineos |
| | | Polybutene | |
| | | Peak MW: 1800 g/mol | |
| | | MW: 2800 g/mol | |
| | TerPIB 2600 | “Type 2” | ter Hell |
| | | Polybutene | |
| | | Peak MW: 11 000 g/mol | |
| | | MW: 9200 g/mol | |
| | Pionier 2070P | “Type 3” | Hansen & |
| | | Naphthenic mineral oil | Rosenthal |
| | | Peak MW: 950 g/mol | |
| | | MW: 920 g/mol | |
| | Trilene CP80 | “Type 1” | Lion Elastomer |
| | | Ethylene-propylene copolymer | |
| | | Peak MW: 28 000 g/mol | |
| | | MW: 35 000 g/mol | |
| | Vistalon 404 | “Type 1” | ExxonMobil |
| | | EPR | |
| | | Peak MW: 2 400 000 g/mol | |
| | | MW: 1 660 000 g/mol | |
| | LIR290 | “Type 1” | Kuraray |
| | | Ethylene-propylene copolymer | |
| | | Peak MW. 42 000 g/mol | |
| | | MW: 36 700 g/mol | |
| | Indopol H6000 | “Type 2” | Ineos |
| | | Polybutene | |
| | | Peak MW. 16 000 g/mol | |
| | | MW: 15 900 g/mol | |
| | Oppanol B10 | “Type 2” | BASF |
| | | Polyisobutylene | |
| | | Peak MW. 33 000 g/mol | |
| | | MW: 43 700 g/mol | |

SEPS: Styrene-ethylene/propylene-styrene block copolymer
SEP: Styrene-ethylene/propylene block copolymer
SEBS: Styrene-ethylene/butylene-styrene block copolymer
DCPD: Dicyclopentadiene polymer
EPR: Ethylene-propylene rubber
PS fraction: Polystyrene fraction
Peak MW: Peak molecular weight
Peak MW*: Peak molecular weight of the triblock copolymer
Peak MW**: Peak molecular weight of the radial block copolymer
KW-Harz: Hydrocarbon resin
Soft. point: Softening point
MW: Weight-average molecular weight

### II. Trials

A series of PSAs of the invention and also corresponding comparative adhesives were produced and were processed to form test adhesive tape specimens. The properties reproduced in the tables were then tested, such as peel adhesion (PEEL), holding power (HP) and thermal shear strength (SAFT). Different aspects were looked at here in each case.

The test specimens were produced as follows: the constituents of the PSAs were dissolved at 30% in special-boiling-point spirit/toluene/acetone and the solution was coated out in the desired layer thickness, using a coating bar, either onto a PET film equipped with a release silicone or onto an etched PET film (thickness 36 μm), after which the solvent was allowed to evaporate off at 100° C. for 15 min and in this way the layer of composition was dried.

TABLE 3
Elastomers/type, M.W.:

| | | I1-1 | I1-2 | I1-3 | I1-4 | I1-5 | I1-6 |
|---|---|---|---|---|---|---|---|
| Elastomer | Septon | 32% | | | | | |
| | 2005 | | | | | | |
| | Kraton | | 40% | | | | |
| | G1650 | | | | | | |
| | Kraton | | | 40% | | | |
| | G1654 | | | | | | |
| | Kraton | | | | 40% | | |
| | G1651 | | | | | | |
| | Kraton | | | | | 40% | |
| | G1633 | | | | | | |
| | YH-602 | | | | | | 40% |
| | Kraton | 8% | 10% | 10% | 10% | 10% | 10% |
| | G1726 | | | | | | |
| Resin | Eastotac | 54% | 45% | 45% | 45% | 45% | 45% |
| | H100W | | | | | | |
| Plasticizer | Kraton | 6% | 5% | 5% | 5% | 5% | 5% |
| | G1750 | | | | | | |

Figures in % are each wt %

| | | | | | | | | | | | | | |
|---|---|---|---|---|---|---|---|---|---|---|---|---|---|
| Peel | Steel | 7.4 | N/cm | 4.0 | N/cm | 5.5 | N/cm | 5.8 | N/cm | 5.2 | N/cm | 5.0 | N/cm |
| adhesion | | | | | | | | | | | | | |
| | PE | 1.1 | N/cm | 3.2 | N/cm | 3.9 | N/cm | 4.1 | N/cm | 3.5 | N/cm | 2.3 | N/cm |
| SAFT (200 g) | | 185° | C. | 123° | C. | 172° | C. | 163° | C. | >210° | C. | 187° | C. |
| HP 80° C., | Steel | >10 000 | min | 2152 | min | >10 000 | min | >10 000 | min | >10 000 | min | >10 000 | min |
| 0.5 kg) | | | | | | | | | | | | | |
| | PP/EPR | 2895 | min | 1997 | min | >10 000 | min | 5098 | min | 5093 | min | >10 000 | min |

| | | C1-7 | C1-8 | C1-9 | C1-10 | C1-11 | C1-12 |
|---|---|---|---|---|---|---|---|
| Elastomer | Kraton | 47.5% | | | | | |
| | G1657 | | | | | | |
| | Septon | | 40% | | | | |
| | 2004 | | | | | | |
| | Septon | | | 40% | | | |
| | 2002 | | | | | | |
| | Kraton | | | | 40% | | |
| | G1642 | | | | | | |
| | Hybrar | | | | | 50% | |
| | 7125 | | | | | | |
| | Septon | | | | | | 48% |
| | 2005 | | | | | | |
| | Kraton | | | 10% | 10% | | 12% |
| | G1726 | | | | | | |
| | Kraton | | 10% | | | | |
| | G1702 | | | | | | |
| Resin | Eastotac | 47.5% | 45% | 45% | 45% | 45% | 36% |
| | H100W | | | | | | |
| Plasticizer | Kraton | | 5% | 5% | 5% | 5% | 4% |
| | G1750 | | | | | | |
| | Indopol | 5% | | | | | |
| | H100 | | | | | | |

Figures in % are each wt %

| | | | | | | | | | | | | | |
|---|---|---|---|---|---|---|---|---|---|---|---|---|---|
| Peel | Steel | 5.5 | N/cm | 4.5 | N/cm | 4.7 | N/cm | 5.3 | N/cm | 0.2 | N/cm | 5.1 | N/cm |
| adhesion | | | | | | | | | | | | | |
| | PE | 2.3 | N/cm | 3.8 | N/cm | 1.5 | N/cm | 1.8 | N/cm | 0.1 | N/cm | 3.1 | N/cm |
| SAFT (200 g) | | 107° | C. | 101° | C. | 86° | C. | 121° | C. | >210° | C. | >210° | C. |

| | | | | | | | | | | | | |
|---|---|---|---|---|---|---|---|---|---|---|---|---|
| HP (80° C., | Steel | —/— | 377 | min | 54 | min | 3 887 | min | 1 824 | min | >10 000 | min |
| 0.5 kg) | | | | | | | | | | | | |
| | PP/EPR | —/— | 908 | min | 26 | min | 18 | min | 804 | min | 181 | min |

TABLE 4
Elastomers/diblock:

| | | I2-1 | I2-2 | I2-3 | I2-4 | C2-5 | V2-6 |
|---|---|---|---|---|---|---|---|
| Elastomer | Kraton | | | | | 30% | |
| | G1651 | | | | | | |
| | Septon | 50% | 35% | 40% | 45% | | |
| | 2005 | | | | | | |
| | Kraton | | | | | 20% | |
| | G1726 | | | | | | |
| | Septon | | 15% | | | | |
| | 1020 | | | | | | |
| | Kraton | | | 10% | 5% | | 50% |
| | G1702 | | | | | | |
| Resin | Eastotac | 45% | 45% | 45% | 45% | 45% | 45% |
| | H100W | | | | | | |
| Plasticizer | Kraton | 5% | 5% | 5% | 5% | 5% | 5% |
| | G1750 | | | | | | |

Figures in % are each wt %

| | | | | | | | | | | | | | |
|---|---|---|---|---|---|---|---|---|---|---|---|---|---|
| Peel | Steel | 7.1 | N/cm | 6.4 | N/cm | 5.6 | N/cm | 6.2 | N/cm | 5.7 | N/cm | 4.3 | N/cm |
| adhesion | | | | | | | | | | | | | |
| | PE | 5.1 | N/cm | 4.1 | N/cm | 4.1 | N/cm | 4.0 | N/cm | 2.6 | N/cm | 3.1 | N/cm |
| SAFT (200 g) | | >210° | C. | 179° | C. | >210° | C. | >210° | C. | 132° | C. | 125° | C. |
| HP (80° C., | Steel | >10 000 | min | >10 000 | min | >10 000 | min | >10 000 | min | >10 000 | min | 294 | min |
| 0.5 kg) | | | | | | | | | | | | | |
| | PP/EPR | >10 000 | min | >10 000 | min | >10 000 | min | 8084 | min | 37 | min | 117 | min |

TABLE 5
Tackifier resin:

| | | I3-1 | I3-2 | I3-3 | C3-4 | C3-5 | C3-6 |
|---|---|---|---|---|---|---|---|
| Elastomer | Septon | | | | | | 50% |
| | 2005 | | | | | | |
| | Kraton | 43% | 43% | | 40% | 40% | |
| | G1654 | | | | | | |
| | Kraton | | | 40% | | | |
| | G1651 | | | | | | |
| | Kraton | 12% | 12% | 10% | 10% | 10% | |
| | G1726 | | | | | | |
| Resin | Eastotac | | | | | | |
| | H100W | | | | | | |
| | Regalite | | | 40% | | | |
| | R1125 | | | | | | |
| | Sukorez | 40% | | | | | |
| | SU120 | | | | | | |
| | Eastotac | | 40% | | | | |
| | H115W | | | | | | |
| | Regalite | | | | 50% | | |
| | R7100 | | | | | | |
| | Sukorez | | | | | 50% | |
| | SU90 | | | | | | |
| | Regalite | | | | | | 45% |
| | R1090 | | | | | | |
| Plasticizer | Kraton | 5% | 5% | 10% | | | 5% |
| | G1750 | | | | | | |

Figures in % are each wt %

| | | | | | | | | | | | | | |
|---|---|---|---|---|---|---|---|---|---|---|---|---|---|
| Peel | Steel | 3.5 | N/cm | 4.8 | N/cm | 5.5 | N/cm | 0.3 | N/cm | 0.4 | N/cm | 8.2 | N/cm |
| adhesion | | | | | | | | | | | | | |
| | PE | 2.3 | N/cm | 2.2 | N/cm | 2.5 | N/cm | 3.3 | N/cm | 2.5 | N/cm | 4.2 | N/cm |
| SAFT (200 g) | | 203° | C. | >210° | C. | 197 | C. | 164° | C. | 169° | C. | >210° | C. |
| HP (80° C., | Steel | >10 000 | min | >10 000 | min | >10 000 | min | >10 000 | min | 4 941 | min | >10 000 | min |
| 0.5 kg) | | | | | | | | | | | | | |
| | PP/EPR | >10 000 | min | >10 000 | min | >10 000 | min | 18 | min | 7 | min | 18 | min |

TABLE 6
Plasticizers:

| | | I4-1 | I4-2 | I4-3 | I4-4 | C4-4 | C4-5 | C4-6 |
|---|---|---|---|---|---|---|---|---|
| Elastomer | Septon | | 45% | 50% | | 50% | 50% | 50% |
| | 2005 | | | | | | | |
| | Kraton | 40% | | | 40% | | | |
| | G1654 | | | | | | | |
| | Kraton | 10% | | | 10% | | | |
| | G1726 | | | | | | | |
| | Kraton | | 5% | | | | | |
| | G1702 | | | | | | | |
| Resin | Eastotac | | 40% | 45% | | 45% | 45% | 45% |
| | H100W | | | | | | | |
| | Regalite | 45% | | | 40% | | | |
| | R1125 | | | | | | | |
| Plasticizer | Kraton | | 10% | | | | | |
| | G1750 | | | | | | | |
| | TerPIB | 5% | | | | | | |
| | 2600 | | | | | | | |
| | Keltan | | | | 10% | | | |
| | 500R | | | | | | | |
| | Pionier | | | 5% | | | | |
| | 2070P | | | | | | | |
| | Trilene | | | | | 5% | | |
| | CP80 | | | | | | | |
| | Vistalon | | | | | | 5% | |
| | 404 | | | | | | | |
| | LIR290 | | | | | | | 5% |

Figures in % are each wt %

| Peel | Steel | 5.1 | N/cm | 5.0 | N/cm | 8.0 | N/cm | 5.3 | N/cm | 7.9 | N/cm | 7.1 | N/cm | 8.8 | |
|---|---|---|---|---|---|---|---|---|---|---|---|---|---|---|---|
| adhesion | | | | | | | | | | | | | | | |
| | PE | 0.8 | N/cm | 3.5 | N/cm | 5.3 | N/cm | 0.3 | N/cm | 5.0 | N/cm | 4.5 | N/cm | 5.3 | |
| SAFT (200 g) | | 186° | C. | >210° | C. | >210° | C. | 184° | C. | >210° | C. | >210° | C. | >210° | C. |
| HP (80° C., | Steel | >10 000 | min | >10 000 | min | 1 842 | min | >10 000 | min | >10 000 | min | >10 000 | min | >10 000 | min |
| 0.5 kg) | | | | | | | | | | | | | | | |
| | PP/EPR | >10 000 | min | 4 528 | min | 804 | min | >10 000 | min | 11 | min | 22 | min | 9 | min |

As is evident from the data made available, the advantageous properties of the PSA of the invention are determined in particular by the combination of selected constituents and their proportions. Hence it is possible to achieve PSAs which even at high temperatures exhibit outstanding peel adhesion on different substrates.

A further example is intended to illustrate that adhesives of the invention have excellent suitability as a functional pressure-sensitive adhesive layer on a carrier material, here a viscoelastic carrier of foamed polyacrylate, for the bonding of a PP/EPR substrate. The formulation used for the functional pressure-sensitive adhesive layer was the composition given in I2-1. A first 50 μm transfer tape of this PSA layer was laminated to the first side of an 800 μm-thick carrier, and a second 50 μm transfer tape of the same PSA layer was laminated to the opposite side of the carrier. The foam carrier used was a layer according to VT5 from DE 10 2012 212 883 A1. The peel adhesion was determined at an angle of 90° at 23° C. and 50% relative humidity with a removal speed of 300 mm/min on PP/EPR (for specification of materials see Test VIIa; for this purpose the adhesive tape was mounted on the test plate according to Test V and equilibrated for 72 h at 23° C. and 50% relative humidity), and foam splitting was found at a force of 52.8 N/cm. A test for thermal shear strength was also conducted. Here a static shear strength (Test VIIa) of >10 000 min was measured.

### Test Methods

All of the measurements for determining adhesive properties were carried out, unless otherwise indicated, at 23° C. and 50% relative humidity.

### Test I—Molar Mass (GPC)

### (a) Peak Molar Mass of Individual Block Copolymer Modes

Polymers are polymodal systems in terms of the molar mass distribution. Mixtures of different polymers may be interpreted as multimodal systems, with each polymer contributing its own molar mass distribution. Mixtures of block copolymers with structures having different molar mass distributions may likewise be interpreted as multimodal systems. Each block copolymer then contributes its own molar mass distribution. For the sake of simplicity, these are referred to here as block copolymer modes.

GPC is appropriate as a metrological method for determining the molar mass of individual polymer modes in mixtures of different polymers. For the block copolymers which can be used in the sense of this invention, produced by living anionic polymerization, the molar mass distributions are typically narrow enough to allow polymer modes—which can be assigned to triblock copolymers, diblock copolymers or multiblock copolymers—to appear with sufficient resolution from one another in the elugram. It is then possible to read off the peak molar mass for the individual polymer modes from the elugrams.

Peak molar masses (Peak MM) are determined by gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and also 10⁴ Å and 10⁶ Å each with ID 8.0 mm×300 mm. The sample concentration is 4 g/l, the flow rate 1.0 ml per minute. Calibration is carried out using the commercially available ReadyCal kit Poly(styrene) high from PSS Polymer Standard Service GmbH, Mainz (μ=μm; 1 Å=10⁻¹⁰ m).

### (b) Weight-Average Molar Mass, Especially of Plasticizers

The weight-average molecular weight MW is determined by gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and also 10⁴ Å and 10⁶ Å each with ID 8.0 mm×300 mm. The sample concentration is 4 g/l, the flow rate 1.0 ml per minute. Calibration is carried out using the commercially available ReadyCal kit Poly(styrene) high from PSS Polymer Standard Service GmbH, Mainz.

### Test II—(Tackifier) Resin Softening Temperature

For individual substances: the (tackifier) resin softening temperature (softening point; soft. point) is performed according to the relevant methodology, which is known as ring & ball and is standardized according to ASTM E28.

### Test III—DACP

5.0 g of test substance (the tackifying resin specimen under investigation) are weighed out into a dry test tube, and 5.0 g of xylene (isomer mixture, CAS [1330-20-7], ≥98.5%, Sigma-Aldrich #320579 or comparable) are added. The test substance is dissolved at 130° C. and the solution is then cooled to 80° C. Any xylene that has escaped is made up for with further xylene, so that 5.0 g of xylene are again present. Then 5.0 g of diacetone alcohol (4-hydroxy-4-methyl-2-pentanone, CAS [123-42-2], 99%, Aldrich #H41544 or comparable) are added. The test tube is shaken until the test substance has dissolved completely. For this purpose the solution is heated to 100° C. The test tube containing the resin solution is then introduced into a Novomatics Chemotronic Cool cloud point measuring instrument and heated therein to 110° C. Cooling is carried out at a cooling rate of 1.0 K/min. The cloud point is detected optically. For this purpose, the temperature at which the turbidity of the solution is 70% is registered. The result is reported in ° C. The lower the DACP, the higher the polarity of the test substance.

### Test IV—MMAP

5.0 g of test substance (the tackifying resin specimen under investigation) are weighed out into a dry test tube, and 10 ml of dry aniline (CAS [62-53-3], 299.5%, Sigma-Aldrich #51788 or comparable) and 5 ml of dry methylcyclohexane (CAS [108-87-2], ≥99%, Sigma-Aldrich #300306 or comparable) are added. The test tube is shaken until the test substance has dissolved completely. For this purpose the solution is heated to 100° C. The test tube containing the resin solution is then introduced into a Novomatics Chemotronic Cool cloud point measuring instrument and heated therein to 110° C. Cooling is carried out at a cooling rate of 1.0 K/min. The cloud point is detected optically. For this purpose, the temperature at which the turbidity of the solution is 70% is registered. The result is reported in ° C. The lower the MMAP, the higher the aromaticity of the test substance.

### Test V—Peel Adhesion

The determination of the peel adhesion (according to AFERA 5001) is conducted as follows. The defined adhesion substrate used is a polished steel plate (Test Va) or a PE plate (Test Vb) of thickness 2 mm. The bondable sheetlike element under investigation (50 μm pressure-sensitive adhesive layer on 36 μm etched PET film) is trimmed to a width of 20 mm and a length of about 25 cm, is provided with a handling section, and immediately thereafter is pressed down five times onto the respective adhesion substrate chosen, using a 4 kg steel roller and an advance rate of 10 m/min. Immediately after that, the bondable sheetlike element is pulled away from the adhesion substrate at an angle of 180° with a tensile tester (from Zwick) at a velocity v=300 mm/min, and the force required for this at room temperature is measured. The measured value (in N/cm) is obtained as a mean value from three individual measurements.

### Test VI—Thermal Shear Strength (SAFT)

This test serves for rapid testing of the shear strength of adhesive tapes under temperature load. For this purpose, the adhesive tape under investigation is adhered to a temperature-controllable steel plate and loaded with a weight (200 g) and the shear distance is recorded.

### Sample Preparation:

The adhesive tape for investigation (50 μm PSA layer on siliconized PET liner) is adhered to an aluminium foil of thickness 50 μm by one of the adhesive sides. The adhesive tape thus prepared is cut to a size of 10 mm*50 mm.

The trimmed adhesive tape sample is bonded by the other adhesive side to a polished test plate cleaned with acetone (material 1.4301, DIN EN 10088-2, surface 2R, surface roughness Rₐ=30 to 60 nm, dimensions 50 mm*13 mm*1.5 mm), the bond being made such that the bond area of the sample in terms of height*width=13 mm*10 mm and the test plate protrudes by 2 mm at the upper edge. Subsequently a 2 kg steel roller is rolled over six times at a speed of 10 m/min for fixing. The sample is reinforced flush at the top with a stable adhesive strip which serves as a contact point for the distance sensor. The sample is then suspended by means of the plate such that the longer protruding end of the adhesive tape points vertically downwards.

### Measurement:

The sample for measurement is loaded at the bottom end with a weight of 50 g. The test plate with the bonded sample is heated starting at 25° C. at a rate of 9 K/min to the final temperature of 200° C.

The distance sensor is used to observe the slip distance of the sample as a function of temperature and time. The maximum slip distance is set at 1000 μm (1 mm); if exceeded, the test is discontinued and the failure temperature is noted. Test conditions: room temperature 23+/−3° C., relative humidity 50+/−5%. The result is reported as the mean value from two individual measurements, in ° C.

### Test VII—Static Shear Strength

The shear strength at 80° C. is a measure of the internal strength of the adhesive at elevated temperature and is tested in a so-called static shear test as follows:

The test is based on PSTC-7 and takes place at 80° C. using a 0.5 kg weight. A strip of this specimen (50 μm pressure-sensitive adhesive layer on 36 μm etched PET film) of width 1.3 cm is adhered on a polished steel plaque over a length of 2 cm and is rolled down back and forth twice using a 2 kg roller. The plaques are equilibrated for 30 minutes under test conditions (80° C.) but without a load. The test weight (0.5 kg) is then hung on, producing a shearing stress parallel to the bond area, and a measurement is made of the time taken for the bond to fail. The result is reported in minutes, and in the case of failure the mode of failure (cohesive fracture or adhesive fracture). The median of three individual measurements is reported. The test substrate is a PP/EPR plate (Test VIIa) or a polished steel plate (Test VIIb). The base material for the PP/EPR plates was Hifax TRC 135X/4 Black from LyondellBasell.

### Test VIII—Glass Transition Temperature

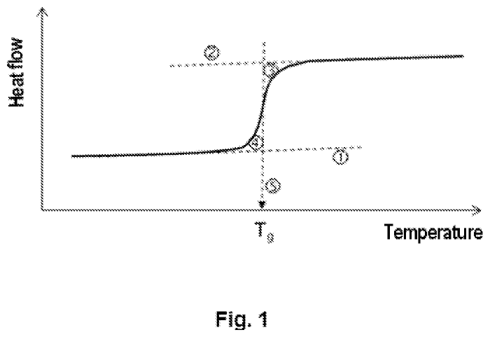

The glass transition temperature is determined by means of dynamic scanning calorimetry (DSC). For this test, about 5 mg of the untreated samples are weighed out into an aluminium crucible (volume 25 μl) and closed with a perforated lid. For the measurement, a DSC 204 F1 from Netzsch is used and is operated under nitrogen for inertization. The sample is first cooled to −150° C., heated to +150° C. at a heating rate of 10 K/min, and cooled again to −150° C. The subsequent second heating curve is run again at 10 K/min, and the change in the heat capacity is recorded. Glass transitions are recognized as steps in the thermogram. The glass transition temperature is evaluated as follows (in this regard, see FIG. 1). A tangent is applied in each case to the baseline of the thermogram before 1 and after 2 of the step. In the region of the step, a line 3 of best fit is placed parallel to the ordinate in such a way that the two tangents intersect, specifically such as to form two areas 4 and 5 (between the respective tangent, the line of best fit, and the measurement plot) of equal content. The point of intersection of the lines of best fit positioned accordingly and the measurement plot gives the glass transition temperature.

### Test IX—Polyvinylaromatic Fraction

The fraction of polyvinylaromatic blocks in hydrogenated polyvinylaromatic-polydiene block copolymers is determined using ¹³C NMR unless otherwise known. The ¹³C NMR is elucidated below using, as an example, the determination of the polystyrene fraction in hydrogenated polystyrene-polydiene block copolymers (SEBS). From the ¹³C spectrum, the mean value is formed from two integrals, namely corresponding to the styrene-C signal at around 144 to 146 ppm and to the styrene-CH at around 125 to 127 ppm. This mean value, for SEBS, is expressed relative to the butylene integral (hydrogenated 1,2-BD), namely the CH3 signal at around 10 ppm, and to the ethylene integral (1,4-BD), which may be obtained by calculation from the total-olefinic integral at around 20 to 50 ppm. The resulting fractions in mol % are then converted to wt %.

1. A pressure-sensitive adhesive comprising:
a) at least 38 wt % and at most 58 wt % of an elastomer component, where
i) the elastomer component comprises at least 60 wt %, based on the elastomer component, of hydrogenated polyvinylaromatic-polydiene block copolymer having a polyvinylaromatic fraction of at least 18 wt % and a peak molecular weight of 80 000 to 500 000 g/mol, determined by GPC (Test I);
ii) the polydiene blocks are substantially fully hydrogenated; and
iii) the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic and B=ethylene and butylene or ethylene and propylene, and Z=derivative of a coupling substance, and where the ethylene fraction in the B blocks is at least 50 wt %;
b) a tackifier resin component,
c) a plasticizer component, and
d) optionally further adjuvants,
where the fraction of the elastomer component is based on the total weight of the pressure-sensitive adhesive.

2. The pressure-sensitive adhesive according to claim 1, characterized in that the polyvinylaromatic-polydiene block copolymers have a polyvinylaromatic fraction of 20 to 36%, preferably 25 to 33%.

3. The pressure-sensitive adhesive according to claim 1, wherein the fraction of elastomer component is 40 to 55 wt %, based in each case on the total weight of the pressure-sensitive adhesive.

4. The pressure-sensitive adhesive according to claim 1, wherein the elastomer component additionally comprises a polyvinylaromatic-polydiene diblock copolymer A′-B′, where it is possible that A′=A and B′=B and the polydiene blocks are substantially fully hydrogenated.

5. The pressure-sensitive adhesive according to claim 4, wherein the elastomer component has at least one hydrogenated diblock copolymer having a peak molecular weight, determined by GPC, of <100 000 g/mol and the fraction thereof based on the elastomer component is at most 25 wt %.

6. The pressure-sensitive adhesive according to claim 4, wherein the elastomer component has at least one hydrogenated diblock copolymer having a peak molecular weight, determined by GPC, of >100 000 g/mol and the fraction thereof based on the elastomer component is at most 40 35 wt %.

7. The pressure-sensitive adhesive according to claim 1, wherein the fraction of tackifier resin component is 35 to 60 wt % based on the total weight of the pressure-sensitive adhesive.

8. The pressure-sensitive adhesive according to claim 1, wherein the tackifier resin component comprises partially or completely hydrogenated resin based on dicyclopentadiene, partially or completely hydrogenated hydrocarbon resins based on C₅, C₅/C₉ or C₉ monomer streams, polyterpene resins based on α-pinene and and/or β-pinene and δ-limonene, or a hydrogenated polymer of pure C₈ or C₉ aromatics, the resin being partially or completely hydrogenated.

9. The pressure-sensitive adhesive according to claim 1, wherein the fraction of plasticizer in the pressure-sensitive adhesive is not more than 20 wt %, based on the total weight of the pressure-sensitive adhesive.

10. The pressure-sensitive adhesive according to claim 1, wherein the plasticizer is selected from the group consisting of ethylene/propylene copolymer, ethylene/butylene copolymer and butylene iso-butylene (co)polymer.

11. The pressure-sensitive adhesive according to claim 10, wherein the plasticizer has a weight-average molar mass of at least 100 000 g/mol and at most 1 000 000 g/mol and is an ethylene/propylene copolymer or ethylene/butylene copolymer with linear or radial structure.

12. The pressure-sensitive adhesive according to claim 10, wherein the plasticizer has a weight-average molar mass of at least 3000 g/mol and at most 20 000 g/mol and is a butylene/isobutylene (co)polymer.

13. An adhesive tape having a carrier which bears at least one applied layer of a pressure-sensitive adhesive according to claim 1.

14. An tape having a foam carrier which bears at least one ply layer of a pressure-sensitive adhesive according to claim 1.

15. A method of bonding a substrate comprising ethylene (co)polymer, propylene (co)polymer, EPR, EPM and/or EPDM, the method comprising the use of the pressure-sensitive adhesive of claim 1.

16. A component, comprising ethylene (co)polymer, propylene (co)polymer, EPR, EPM and/or EPDM, bearing an adhesive tape applied by means of a pressure-sensitive adhesive according to claim 1.

17. The adhesive tape of claim 13 wherein the carrier is a foam carrier.

18. The adhesive tape of claim 14 wherein the foam carrier is a viscoelastic foamed poly(meth)acrylate layer.

19. The component of claim 16, wherein the adhesive tape comprises a foamed carrier.
